(19) United States
(12) Patent Application Publication
(10) Pub. No.: US 2025/0021323 A1
(43) Pub. Date: Jan. 16, 2025

(54) CPLD FIRMWARE OVER THE AIR UPDATES FOR AUTONOMOUS VEHICLES

(71) Applicant: Apollo Autonomous Driving USA LLC, Sunnyvale, CA (US)

(72) Inventor: QIANG WANG, Cupertino, CA (US)

(21) Appl. No.: 18/220,470

(22) Filed: Jul. 11, 2023

(51) Int. Cl. G06F 8/65; G06F 13/42; G06F 21/64

(52) U.S. Cl. CPC G06F 8/65; G06F 13/4282; G06F 21/64; G06F 2213/0016

(57) ABSTRACT

In one embodiment, a system determines a version identifier of a first firmware version at a complex programmable logic device (CPLD) executing the first firmware version. The system determines a second firmware version for the CPLD is available to the CPLD via a FOTA process, where a version identifier of the second firmware version is different from the version identifier of the first firmware version. The system performs a write operation to write data blocks corresponding to the second firmware version of the CPLD to a memory address of a data buffer of the CPLD in a block-by-block manner. The system instructs the CPLD to transfer the data blocks corresponding to the second firmware version from the data buffer to a configuration memory of the CPLD. The system causes the second firmware version at the configuration memory of the CPLD to load onto the CPLD.

### TECHNICAL FIELD

Embodiments of the present disclosure relate generally to operating autonomous driving vehicles. More particularly, embodiments of the disclosure relate to complex programmable logic device (CPLD) firmware over the air (FOTA) updates for autonomous driving vehicles (ADVs).

### BACKGROUND

Vehicles operating in an autonomous mode (e.g., driverless) can relieve occupants, especially the driver, from some driving-related responsibilities. When operating in an autonomous mode, the vehicle can navigate to various locations using onboard sensors, allowing the vehicle to travel with minimal human interaction or in some cases without any passengers.

Autonomous vehicles can use complex programmable logic devices (CPLDs) to implement various digital logics. CPLD is a type of programmable logic device that is used to implement digital logics. A CPLD has a matrix of programmable logic blocks (PLBs) connected by programmable interconnects, and has input/output blocks (IOBs) for interfacing with external devices. The PLBs contain logic functions and are fully programmable. The IOBs provide I/O interfaces between the CPLD and external devices. IOBs allow signals to enter and exit the CPLD and can be configured as input, output, or bidirectional ports. The programmable interconnects connect the PLBs and IOBs and allow the CPLD to route signals between them. The interconnects are programmable and can be configured to create a wide range of routing paths.

The CPLD also has a configuration memory that stores the configuration data that defines the behavior of the CPLD. The configuration memory typically is a non-volatile memory such as flash memory or electrically erasable programmable read-only memory (EEPROM).

### BRIEF DESCRIPTION OF THE DRAWINGS

Embodiments of the disclosure are illustrated by way of example and not limitation in the figures of the accompanying drawings in which like references indicate similar elements.

FIG. 1 is a block diagram illustrating a networked system according to one embodiment.

FIG. 2 is a block diagram illustrating an example of an autonomous driving vehicle according to one embodiment.

FIGS. 3A-3B are block diagrams illustrating an example of an autonomous driving system used with an autonomous driving vehicle according to one embodiment.

FIG. 4A is a block diagram illustrating an example of an autonomous driving vehicle employing one or more CPLDs according to one embodiment.

FIG. 4B is a block diagram illustrating an example of a FOTA update module according to one embodiment.

FIG. 5 is a block diagram illustrating an example of firmware over the air (FOTA) logic blocks according to one embodiment.

FIG. 6 is a block diagram illustrating an example of an I2C read transaction according to one embodiment.

FIG. 7 is a block diagram illustrating an example of an I2C write transaction according to one embodiment.

FIG. 8 is a flow diagram illustrating a method to perform FOTA update according to one embodiment.

### DETAILED DESCRIPTION

Various embodiments and aspects of the disclosure will be described with reference to details discussed below, and the accompanying drawings will illustrate the various embodiments. The following description and drawings are illustrative of the disclosure and are not to be construed as limiting the disclosure. Numerous specific details are described to provide a thorough understanding of various embodiments of the present disclosure. However, in certain instances, well-known or conventional details are not described in order to provide a concise discussion of embodiments of the present disclosure.

Reference in the specification to “one embodiment” or “an embodiment” means that a particular feature, structure, or characteristic described in conjunction with the embodiment can be included in at least one embodiment of the disclosure. The appearances of the phrase “in one embodiment” in various places in the specification do not necessarily all refer to the same embodiment.

According to some embodiments, complex programmable logic devices (CPLDs) employed at an autonomous driving vehicle (ADV) require continuous updates to deploy new features. A firmware over the air (FOTA) update can be applied to CPLDs wirelessly. The autonomous vehicle computing system (or host system) can retrieve new firmware data over the air and load the new firmware data to a temporary data buffer on the CPLD via an I2C slave interface. The host system directs the new firmware data in the temporary data buffer to be transferred to the configuration memory of the CPLD, and instructs the CPLD to load the new firmware data from the configuration memory of the CPLD.

Conventionally, an operator updates the firmware on a CPLD by connecting a physical cable (such as a JTAG connector) of a CPLD to a host system and switches the CPLD to a programmable mode (such as in-system programming (ISP) mode). When in the ISP mode, the logic functions of the CPLD are halted, and the configuration memory of the CPLD is erased and loaded with new configuration data from the host computer. Periodic updates due to modifications and/or new features on multiple CPLDs of an autonomous driving vehicle (ADV) computing system is, however, cumbersome.

A conventional firmware over the air (FOTA) controller can be used for wireless CPLD updates but a FOTA controller for a CPLD uses a significant amount of logic resource from the CPLD and requires additional storage space to store new versions of the firmware locally. Because a CPLD has limited logic resources, a customized FOTA update system/method using the inter-integrated controller (I2C) protocol can minimize CPLD logic resources expenditures.

In some embodiments, an autonomous driving computing platform (or host system) makes available, to a complex programmable logic device (CPLD), an I2C port. The I2C port can be made available directly (e.g., through VGA, DVI, or HDMI ports that use the display data channel (DDC) to communicate, where the DDC uses an I2C interface) or indirectly (e.g., through an I2C interface adapter such as a USB to I2C adapter). The host system acting as an I2C master can push firmware versions to the CPLD that is acting as an I2C slave. In one embodiment, the host system determines a version identifier of the first firmware version at a complex programmable logic device (CPLD) executing a first firmware version. The host system determines a second firmware version for the CPLD is available to the CPLD via a FOTA process, where a version identifier of the second firmware version is different from the version identifier of the first firmware version. The host system performs a write operation to write data blocks corresponding to the second firmware version (e.g., update version) of the CPLD to a memory address of a data buffer of the CPLD in a block-by-block manner. The host system instructs the CPLD to transfer the data blocks corresponding to the second firmware version from the data buffer to a configuration memory of the CPLD and causes the second firmware version at the configuration memory of the CPLD to load onto the CPLD.

In some embodiments, a microcontroller (MCU) can bridge the communication between the host system and the CPLD, where the microcontroller relays the bidirectional communication packets between the host system and the CPLD. Here, the host system and the microcontroller (MCU) can exchange data through Ethernet communication while communication between the MCU and the CPLD can be performed through the I2C protocol. In some embodiments, the microcontroller acts as the I2C master while the CPLD acts as the I2C slave.

I2C refers to a synchronous, multi-master/multi-slave, packet switched, single-ended, serial communication protocol. I2C allows a host system (I2C master) to communicate with one or more I2C slaves (e.g., one or more CPLDs). I2C uses two signal pins. One pin is for data signals (SDA), and another pin is for clock signals (SCL).

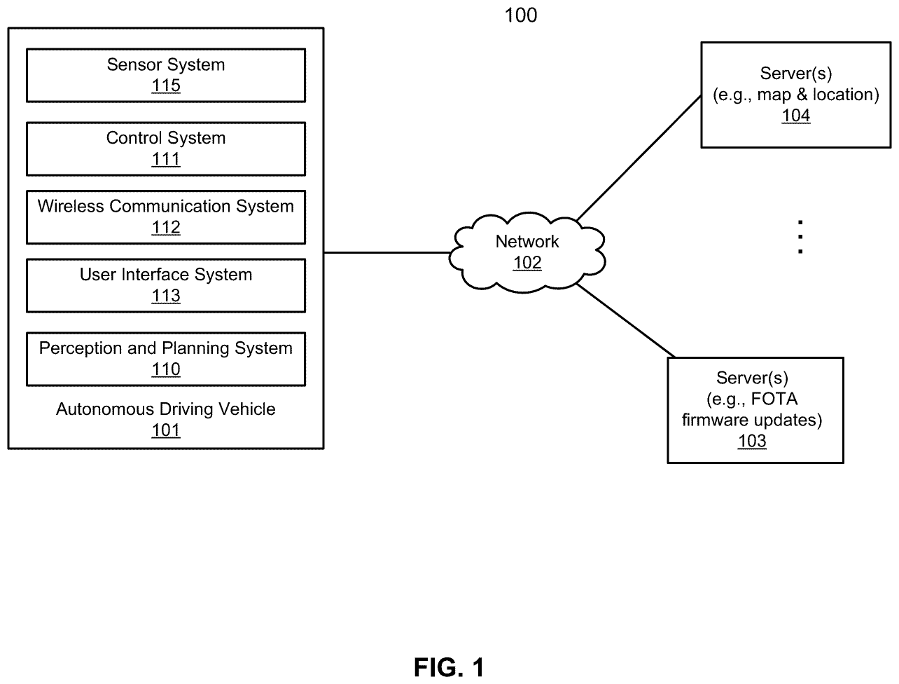

FIG. 1 is a block diagram illustrating an autonomous driving network configuration according to one embodiment of the disclosure. Referring to FIG. 1, network configuration 100 includes autonomous driving vehicle (ADV) 101 that may be communicatively coupled to one or more servers 103-104 over a network 102. Although there is one ADV shown, multiple ADVs can be coupled to each other and/or coupled to servers 103-104 over network 102. Network 102 may be any type of networks such as a local area network (LAN), a wide area network (WAN) such as the Internet, a cellular network, a satellite network, or a combination thereof, wired or wireless. Server(s) 103-104 may be any kind of servers or a cluster of servers, such as Web or cloud servers, application servers, backend servers, or a combination thereof. Servers 103-104 may be data analytics servers, content servers, traffic information servers, map and point of interest (MPOI) servers, or location servers, etc.

An ADV refers to a vehicle that can be configured to in an autonomous mode in which the vehicle navigates through an environment with little or no input from a driver. Such an ADV can include a sensor system having one or more sensors that are configured to detect information about the environment in which the vehicle operates. The vehicle and its associated controller(s) use the detected information to navigate through the environment. ADV 101 can operate in a manual mode, a full autonomous mode, or a partial autonomous mode.

In one embodiment, ADV 101 includes, but is not limited to, autonomous driving system (ADS) 110, vehicle control system 111, wireless communication system 112, user interface system 113, and sensor system 115. ADV 101 may further include certain common components included in ordinary vehicles, such as, an engine, wheels, steering wheel, transmission, etc., which may be controlled by vehicle control system 111 and/or ADS 110 using a variety of communication signals and/or commands, such as, for example, acceleration signals or commands, deceleration signals or commands, steering signals or commands, braking signals or commands, etc.

Components 110-115 may be communicatively coupled to each other via an interconnect, a bus, a network, or a combination thereof. For example, components 110-115 may be communicatively coupled to each other via a controller area network (CAN) bus. A CAN bus is a vehicle bus standard designed to allow microcontrollers and devices to communicate with each other in applications without a host computer. It is a message-based protocol, designed originally for multiplex electrical wiring within automobiles, but is also used in many other contexts.

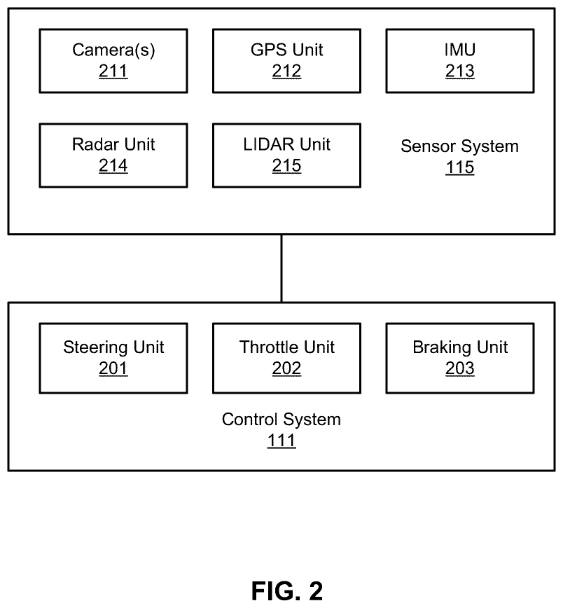

Referring now to FIG. 2, in one embodiment, sensor system 115 includes, but it is not limited to, one or more cameras 211, global positioning system (GPS) unit 212, inertial measurement unit (IMU) 213, radar unit 214, and a light detection and range (LIDAR) unit 215. GPS system 212 may include a transceiver operable to provide information regarding the position of the ADV. IMU unit 213 may sense position and orientation changes of the ADV based on inertial acceleration. Radar unit 214 may represent a system that utilizes radio signals to sense objects within the local environment of the ADV. In some embodiments, in addition to sensing objects, radar unit 214 may additionally sense the speed and/or heading of the objects. LIDAR unit 215 may sense objects in the environment in which the ADV is located using lasers. LIDAR unit 215 could include one or more laser sources, a laser scanner, and one or more detectors, among other system components. Cameras 211 may include one or more devices to capture images of the environment surrounding the ADV. Cameras 211 may be still cameras and/or video cameras. A camera may be mechanically movable, for example, by mounting the camera on a rotating and/or tilting a platform.

Sensor system 115 may further include other sensors, such as, a sonar sensor, an infrared sensor, a steering sensor, a throttle sensor, a braking sensor, and an audio sensor (e.g., microphone). An audio sensor may be configured to capture sound from the environment surrounding the ADV. A steering sensor may be configured to sense the steering angle of a steering wheel, wheels of the vehicle, or a combination thereof. A throttle sensor and a braking sensor sense the throttle position and braking position of the vehicle, respectively. In some situations, a throttle sensor and a braking sensor may be integrated as an integrated throttle/braking sensor.

In one embodiment, vehicle control system 111 includes, but is not limited to, steering unit 201, throttle unit 202 (also referred to as an acceleration unit), and braking unit 203. Steering unit 201 is to adjust the direction or heading of the vehicle. Throttle unit 202 is to control the speed of the motor or engine that in turn controls the speed and acceleration of the vehicle. Braking unit 203 is to decelerate the vehicle by providing friction to slow the wheels or tires of the vehicle. Note that the components as shown in FIG. 2 may be implemented in hardware, software, or a combination thereof.

Referring back to FIG. 1, wireless communication system 112 is to allow communication between ADV 101 and external systems, such as devices, sensors, other vehicles, etc. For example, wireless communication system 112 can wirelessly communicate with one or more devices directly or via a communication network, such as servers 103-104 over network 102. Wireless communication system 112 can use any cellular communication network or a wireless local area network (WLAN), e.g., using WiFi to communicate with another component or system. Wireless communication system 112 could communicate directly with a device (e.g., a mobile device of a passenger, a display device, a speaker within vehicle 101), for example, using an infrared link, Bluetooth, etc. User interface system 113 may be part of peripheral devices implemented within vehicle 101 including, for example, a keyboard, a touch screen display device, a microphone, and a speaker, etc.

Some or all of the functions of ADV 101 may be controlled or managed by ADS 110, especially when operating in an autonomous driving mode. ADS 110 includes the necessary hardware (e.g., processor(s), memory, storage) and software (e.g., operating system, planning and routing programs) to receive information from sensor system 115, control system 111, wireless communication system 112, and/or user interface system 113, process the received information, plan a route or path from a starting point to a destination point, and then drive vehicle 101 based on the planning and control information. Alternatively, ADS 110 may be integrated with vehicle control system 111.

For example, a user as a passenger may specify a starting location and a destination of a trip, for example, via a user interface. ADS 110 obtains the trip related data. For example, ADS 110 may obtain location and route data from an MPOI server, which may be a part of servers 103-104. The location server provides location services and the MPOI server provides map services and the POIs of certain locations. Alternatively, such location and MPOI information may be cached locally in a persistent storage device of ADS 110.

While ADV 101 is moving along the route, ADS 110 may also obtain real-time traffic information from a traffic information system or server (TIS). Note that servers 103-104 may be operated by a third party entity. Alternatively, the functionalities of servers 103-104 may be integrated with ADS 110. Based on the real-time traffic information, MPOI information, and location information, as well as real-time local environment data detected or sensed by sensor system 115 (e.g., obstacles, objects, nearby vehicles), ADS 110 can plan an optimal route and drive vehicle 101, for example, via control system 111, according to the planned route to reach the specified destination safely and efficiently.

Server 103 can be a FOTA update system that performs firmware update services for one or more clients (e.g., ADVs). For example, software development/production team can upload new firmware updates to server 103. Server 103 can push the new firmware updates to the autonomous driving computing system 110 of autonomous driving vehicle 101.

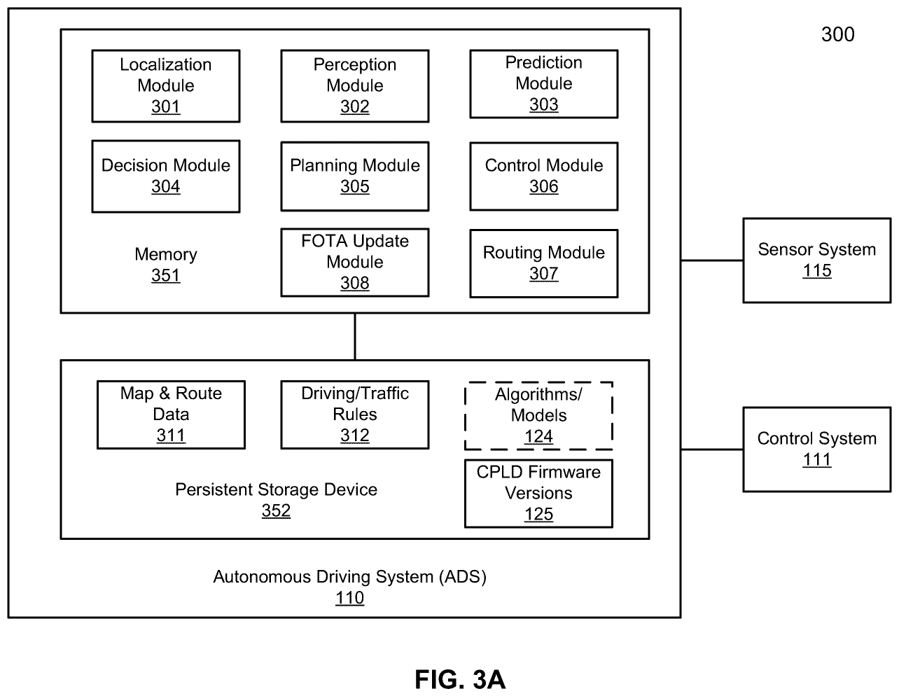

FIGS. 3A and 3B are block diagrams illustrating an example of an autonomous driving system used with an ADV according to one embodiment. System 300 may be implemented as a part of ADV 101 of FIG. 1 including, but is not limited to, ADS 110, control system 111, and sensor system 115. Referring to FIGS. 3A-3B, ADS 110 includes, but is not limited to, localization module 301, perception module 302, prediction module 303, decision module 304, planning module 305, control module 306, routing module 307, and FOTA update module 308.

Some or all of modules 301-308 may be implemented in software, hardware, or a combination thereof. For example, these modules may be installed in persistent storage device 352, loaded into memory 351, and executed by one or more processors (not shown). Note that some or all of these modules may be communicatively coupled to or integrated with some or all modules of vehicle control system 111 of FIG. 2. Some of modules 301-308 may be integrated together as an integrated module.

Localization module 301 determines a current location of ADV 101 (e.g., leveraging GPS unit 212) and manages any data related to a trip or route of a user. Localization module 301 (also referred to as a map and route module) manages any data related to a trip or route of a user. A user may log in and specify a starting location and a destination of a trip, for example, via a user interface. Localization module 301 communicates with other components of ADV 101, such as map and route data 311, to obtain the trip related data. For example, localization module 301 may obtain location and route data from a location server and a map and POI (MPOI) server. A location server provides location services and an MPOI server provides map services and the POIs of certain locations, which may be cached as part of map and route data 311. While ADV 101 is moving along the route, localization module 301 may also obtain real-time traffic information from a traffic information system or server.

Based on the sensor data provided by sensor system 115 and localization information obtained by localization module 301, a perception of the surrounding environment is determined by perception module 302. The perception information may represent what an ordinary driver would perceive surrounding a vehicle in which the driver is driving. The perception can include the lane configuration, traffic light signals, a relative position of another vehicle, a pedestrian, a building, crosswalk, or other traffic related signs (e.g., stop signs, yield signs), etc., for example, in a form of an object. The lane configuration includes information describing a lane or lanes, such as, for example, a shape of the lane (e.g., straight or curvature), a width of the lane, how many lanes in a road, one-way or two-way lane, merging or splitting lanes, exiting lane, etc.

Perception module 302 may include a computer vision system or functionalities of a computer vision system to process and analyze images captured by one or more cameras in order to identify objects and/or features in the environment of the ADV. The objects can include traffic signals, road way boundaries, other vehicles, pedestrians, and/or obstacles, etc. The computer vision system may use an object recognition algorithm, video tracking, and other computer vision techniques. In some embodiments, the computer vision system can map an environment, track objects, and estimate the speed of objects, etc. Perception module 302 can also detect objects based on other sensors data provided by other sensors such as a radar and/or LIDAR.

For each of the objects, prediction module 303 predicts what the object will behave under the circumstances. The prediction is performed based on the perception data perceiving the driving environment at the point in time in view of a set of map/route information 311 and traffic rules 312. For example, if the object is a vehicle at an opposing direction and the current driving environment includes an intersection, prediction module 303 will predict whether the vehicle will likely move straight forward or make a turn. If the perception data indicates that the intersection has no traffic light, prediction module 303 may predict that the vehicle may have to fully stop prior to enter the intersection. If the perception data indicates that the vehicle is currently at a left-turn only lane or a right-turn only lane, prediction module 303 may predict that the vehicle will more likely make a left turn or right turn respectively.

For each of the objects, decision module 304 makes a decision regarding how to handle the object. For example, for a particular object (e.g., another vehicle in a crossing route) as well as its metadata describing the object (e.g., a speed, direction, turning angle), decision module 304 decides how to encounter the object (e.g., overtake, yield, stop, pass). Decision module 304 may make such decisions according to a set of rules such as traffic rules or driving rules 312, which may be stored in persistent storage device 352.

Routing module 307 is configured to provide one or more routes or paths from a starting point to a destination point. For a given trip from a start location to a destination location, for example, received from a user, routing module 307 obtains route and map information 311 and determines all possible routes or paths from the starting location to reach the destination location. Routing module 307 may generate a reference line in a form of a topographic map for each of the routes it determines from the starting location to reach the destination location. A reference line refers to an ideal route or path without any interference from others such as other vehicles, obstacles, or traffic condition. That is, if there is no other vehicle, pedestrians, or obstacles on the road, an ADV should exactly or closely follows the reference line. The topographic maps are then provided to decision module 304 and/or planning module 305. Decision module 304 and/or planning module 305 examine all of the possible routes to select and modify one of the most optimal routes in view of other data provided by other modules such as traffic conditions from localization module 301, driving environment perceived by perception module 302, and traffic condition predicted by prediction module 303. The actual path or route for controlling the ADV may be close to or different from the reference line provided by routing module 307 dependent upon the specific driving environment at the point in time.

Based on a decision for each of the objects perceived, planning module 305 plans a path or route for the ADV, as well as driving parameters (e.g., distance, speed, and/or turning angle), using a reference line provided by routing module 307 as a basis. That is, for a given object, decision module 304 decides what to do with the object, while planning module 305 determines how to do it. For example, for a given object, decision module 304 may decide to pass the object, while planning module 305 may determine whether to pass on the left side or right side of the object. Planning and control data is generated by planning module 305 including information describing how vehicle 101 would move in a next moving cycle (e.g., next route/path segment). For example, the planning and control data may instruct vehicle 101 to move 10 meters at a speed of 30 miles per hour (mph), then change to a right lane at the speed of 25 mph.

Based on the planning and control data, control module 306 controls and drives the ADV, by sending proper commands or signals to vehicle control system 111, according to a route or path defined by the planning and control data. The planning and control data include sufficient information to drive the vehicle from a first point to a second point of a route or path using appropriate vehicle settings or driving parameters (e.g., throttle, braking, steering commands) at different points in time along the path or route.

In one embodiment, the planning phase is performed in a number of planning cycles, also referred to as driving cycles, such as, for example, in every time interval of 100 milliseconds (ms). For each of the planning cycles or driving cycles, one or more control commands will be issued based on the planning and control data. That is, for every 100 ms, planning module 305 plans a next route segment or path segment, for example, including a target position and the time required for the ADV to reach the target position. Alternatively, planning module 305 may further specify the specific speed, direction, and/or steering angle, etc. In one embodiment, planning module 305 plans a route segment or path segment for the next predetermined period of time such as 5 seconds. For each planning cycle, planning module 305 plans a target position for the current cycle (e.g., next 5 seconds) based on a target position planned in a previous cycle. Control module 306 then generates one or more control commands (e.g., throttle, brake, steering control commands) based on the planning and control data of the current cycle.

Note that decision module 304 and planning module 305 may be integrated as an integrated module. Decision module 304/planning module 305 may include a navigation system or functionalities of a navigation system to determine a driving path for the ADV. For example, the navigation system may determine a series of speeds and directional headings to affect movement of the ADV along a path that substantially avoids perceived obstacles while generally advancing the ADV along a roadway-based path leading to an ultimate destination. The destination may be set according to user inputs via user interface system 113. The navigation system may update the driving path dynamically while the ADV is in operation. The navigation system can incorporate data from a GPS system and one or more maps so as to determine the driving path for the ADV.

FOTA update module 308 can receive a firmware version from a remote server, such as server 103, via an application programming interface (API), and perform a FOTA update for local programmable logic devices (e.g., simple programmable logic devices (SPLD), CPLDs, FPGAs, etc.) at the ADV 101.

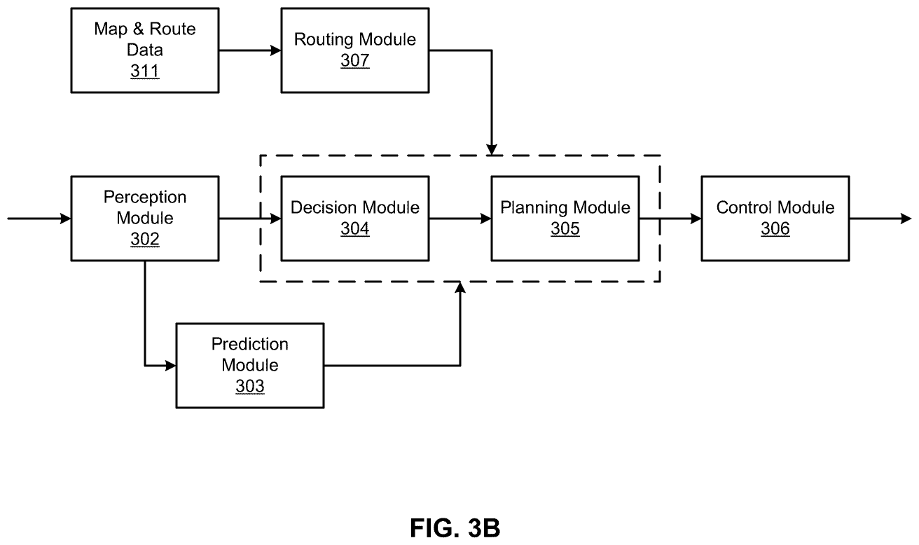

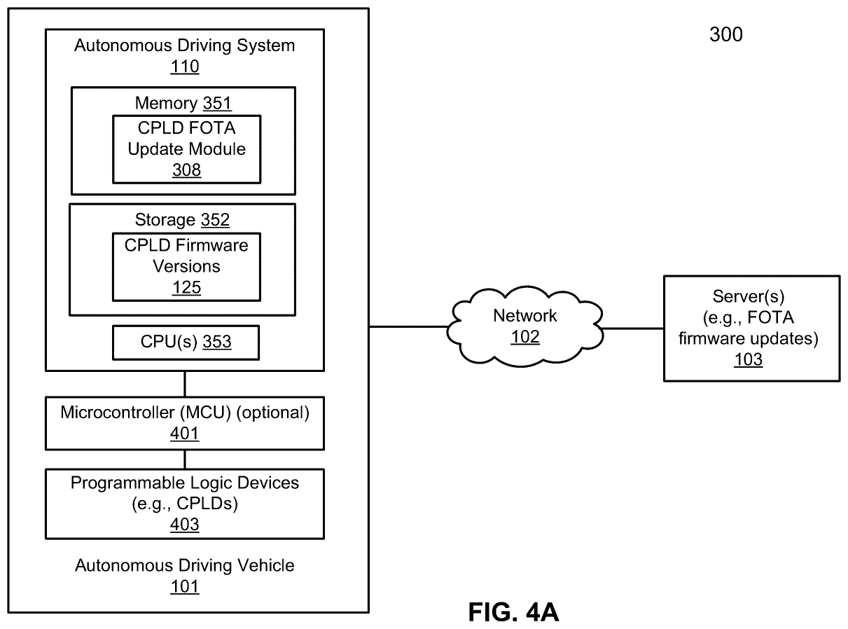

FIG. 4A is a block diagram illustrating an example of an autonomous driving vehicle employing one or more Complex Programmable Logic Device (CPLDs) 403 according to one embodiment. Referring to FIG. 4A, system 300 illustrates ADS 110 includes one or more CPUs 353 and ADS 110 is communicatively coupled to the one or more CPLDs 403 indirectly via a MCU agent or directly through an I2C interface. Although CPLD is shown, the programmable logic devices can be an SPLD, or FPGA, or other programmable logic devices that have programmable logics. FPGA functions similar to a CPLD. In contrast to a CPLD, a FPGA contains more logic blocks than CPLD, and FPGA can be used in more demanding and more complex applications.

In some embodiments, the programmable logic devices at an ADS of an ADV can perform a power on or a power reset operation for a peripheral component interconnect express (PCIe) device of the ADS, or perform a power on or power reset operation for one or more sensors of the ADV. The CPLD can also implement signal pre- or post-processing logics for sensor signals or other autonomous driving logic blocks, such as routing, planning, perception, control, etc.

In one embodiment, a microcontroller 401 serves as a forwarding device to bridge the communication between the ADS 110 and CPLDs 403. Here, microcontroller 401 can communicate with ADS 110 wirelessly over ethernet communication or through a physical cable interface (such as the COM or RS232 port of a computing system). Microcontroller 401 can then communicate with CPLDs 403 via an I2C interface. Although FIG. 4A shows CPLDs 403 are separate from ADS 110, in some embodiments, CPLDs 403 can be integrated with ADS 110.

FIG. 4B is a block diagram illustrating an example of a FOTA update module 308 according to one embodiment. FOTA update module 308 can perform a FOTA update for a CPLD at an ADV 101. Referring to FIG. 4B, FOTA update module 308 can include firmware receiver submodule 411, checksum submodule 413, read submodule 415, write submodule 417, transfer submodule 419, reload configuration submodule 421, and check complete submodule 423. Firmware receiver submodule 411 can receive a version of a firmware from a server, such as server 103. Checksum submodule 413 can perform an integrity check (such as a checksum) on the received firmware. A checksum is a value that represents the number of bits in a transmission message and can be used to detect bit errors within data transmissions. The integrity check ensures the received firmware version is not corrupted and matches an expected version of the firmware. Read submodule 415 can perform a read operation from a memory address of the CPLD. The memory address can refer to an address of a data buffer, a register file, configuration memory, or CSR at the CPLD. In one embodiment, a lower address space is used for the register file, and a higher address space is used for the data buffer.

Write submodule 417 can perform a write operation to a memory address of the CPLD. Transfer submodule 419 can move data from data buffer of the CPLD to the configuration (CFG) memory. Reload configuration submodule 421 can cause the CPLD to reload the firmware from the CFG memory. Check complete submodule 423 can check that a firmware version update is complete. Some or all of modules 411-423 may be implemented in software, hardware, or a combination thereof. Some or all of modules 411-423 may be integrated together as an integrated module.

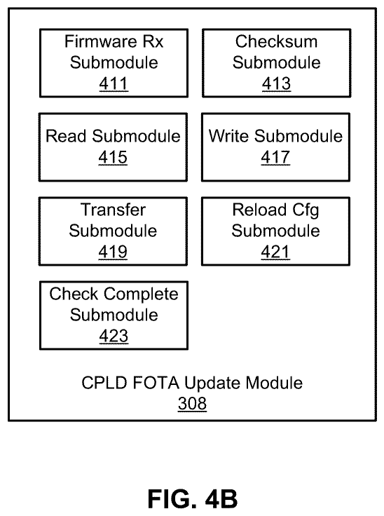

FIG. 5 is a block diagram 500 illustrating an example of firmware over the air (FOTA) logic blocks according to one embodiment. Referring to FIG. 5, ADS 110 (or host system) can communicate with a MCU 401 through Ethernet interface. MCU 401 can act as an agent with an algorithm on MCU 401 that forwards I2C communication transactions between the host system and the CPLD. Here, MCU 401 can connect to a target programmable logic device (CPLD) 403 through an I2C interface.

In some embodiments, programmable logic device 403 (such as a CPLD) can implement the logic blocks for I2C slave 501, data buffer 503, reg file 505, and local bus master 507, configuration (CFG) memory interface 509, CSR 511, and CFG memory 513. CFG memory 513 can be a flash memory or an embedded memory that store programming code for the CPLD. Depending on the specific CPLD model being used, some logic blocks may be implemented by external device. For example, some CPLDs may offer external memory interfaces, allowing the CPLD to interface with external cache or memory components.

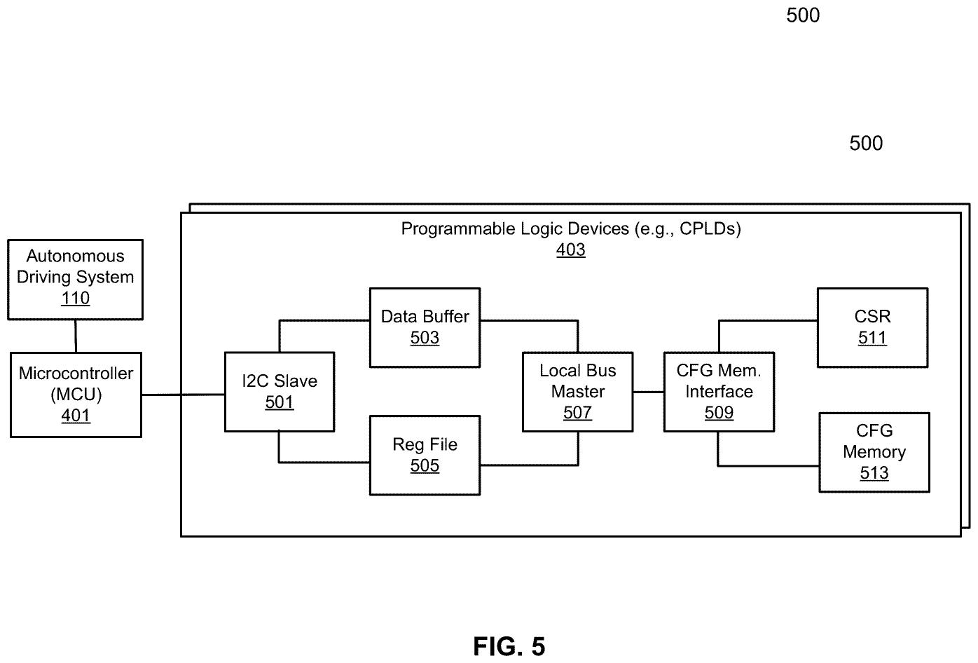

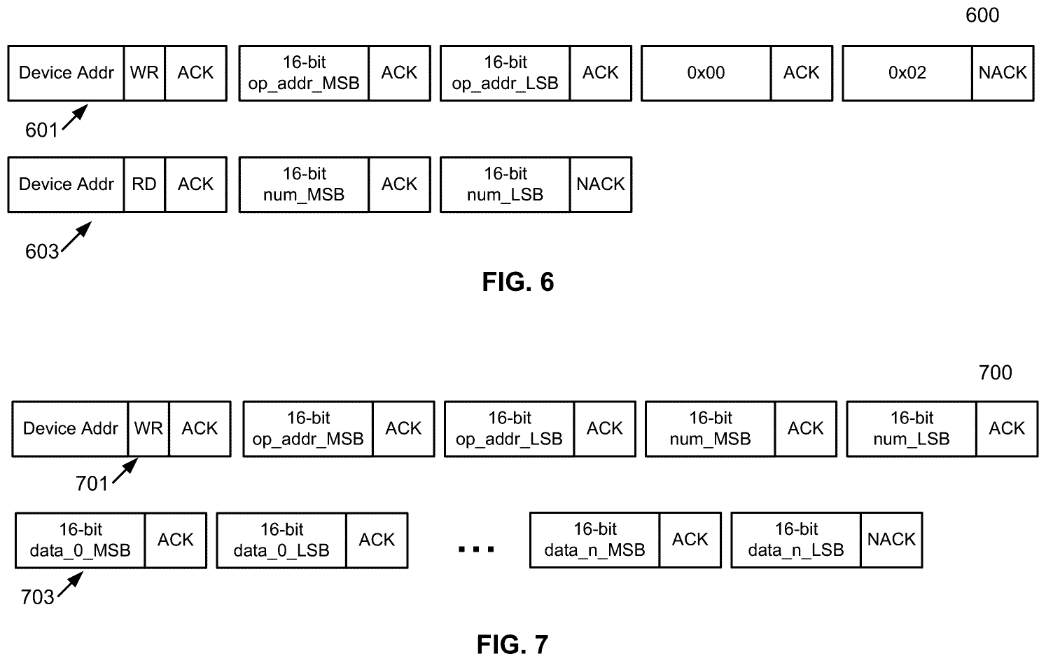

Referring to FIG. 5, I2C slave 501 can be configured to encode/decode read/write I2C commands and retrieve values from configuration control and status registers (CSR). Examples of a read and a write transaction is further illustrated in FIGS. 6-7, respectively. Data buffer 503 can be a temporary storage unit that can hold data for a short period of time. Data buffer 503 can be used to temporarily hold data that is being transferred between different parts of the CPLD. Here, data buffer 503 can temporarily store a firmware version that is being updated to the CPLD. An example size of data buffer 503 can be 256 bytes. Reg file 505 can be a collection of registers that are used to store data for use by the CPLD. Register file 505 can be used to store data that needs to be accessed frequently or that needs to be available for a longer period of time, such as memory address values at the CPLD. Register file 505 can store memory address locations that specifies data buffer, configuration memory, or CSR on the CPLD. Local bus master 507 can manage data transfers from data buffer 503 to memory interface 509 (e.g., CPLD configuration memory 513 or configuration control and status registers (CSR) 511). Here, interactions between data buffer 503 and CPLD configuration memory 513 or configuration control and status register 511 are managed through local bus master 507 and controlled through values set in register file 505.

In one embodiment, bitstream data for a firmware update is transferred from host system 110 to data buffer 503 in a block-by-block manner. In one embodiment, each block can be an I2C transaction, e.g., one or two bytes plus an ACK/NACK bit, but other block sizes are possible. Block-by-block transfers is a way of transferring data between the CPLD and external devices (e.g., host system). In block-by-block transfers, the data is transferred one block at a time, where each block containing a fixed number of data words. The transfer of each block is initiated by the CPLD, and the data is transferred until the block is complete.

In one embodiment, when the firmware version is received at data buffer 503. The FOTA logic at local host master instructs the firmware version at data buffer 503 to be moved to CPLD configuration memory in a burst manner (e.g., multiple blocks are transferred at a time). Data buffer burst mode transfer to configuration memory refers to the process of transferring data from the data buffer to the configuration memory in burst mode. The burst mode transfer allows for a high speed CPLD FOTA process. Host system can check settings register (CSR) to determine if a transfer is complete before instructing the CPLD to reload firmware data from configuration memory.

FIG. 6 is a block diagram illustrating an example of an I2C read transaction 600 according to one embodiment. The I2C read transaction can be used by the host system to read information (such as a version identifier of firmware that is loaded at the CPLD, or a memory address location for a configuration memory) from the CPLD. In one embodiment, a read transaction 600 includes one write operation 601 and one read operation 603 conforming to the I2C protocol, where host system 110 posts a write operation 601 followed by a read operation 603. For write operation 601, the device address denotes the CPLD peripheral address. WR denotes the operation is a write request and RD denotes the operation is a read request. Op_addr denotes a 16-bit target address, separated by 8-bit most significant byte (MSB) and 8-bit least significant byte (LSB). Op_addr can specifies where data is being read/written. 0x00 and 0x02 denotes that two bytes are being read. The I2C protocol includes an ACK/NACK at the end of each data block. ACK denotes additional I2C data block is to follow and NACK denotes the end of the read/write operation, e.g., no additional data block is associated with the read/write operation.

Referring to read operation 603, once host system 110 posts the write operation and the read I2C data block, CPLD peripheral would post the values from the op_addr to 8-bit num_MSB and 8-bit num_LSB. The read operation typically can be used to retrieve register values to determine a status of the CPLD or to determine memory addresses where firmware version data is stored.

FIG. 7 is a block diagram illustrating an example of an I2C write transaction 700 according to one embodiment. Write transaction 700 can be used to transfer a firmware version from host system to data buffer of CPLD. In one embodiment, write transaction 700 includes device address denoting the particular CPLD peripheral device being written to; Op_addr denotes the target memory address to write to (e.g., data buffer or register file locations); 8 num_MSB and 8 num_LSB denotes a value corresponding to the number of bytes to write to the target memory address. The payload (firmware data) is specified at data_0 . . . data_n, where ACK denotes additional data block to follow for the write operation, NACK denotes a last data block for the write operation.

In some embodiments, once firmware data is transferred to data buffer. Host system can specify a memory location at reg file corresponding to the CFG memory of the CPLD and initiate local bus master logic to transfer the data from data buffer to the CFG memory. Host system can read CSR or other settings register to check that the transfer is complete (e.g., CPLD is idle). Host system can then cause the CPLD to restart to load the firmware at CFG memory to the CPLD.

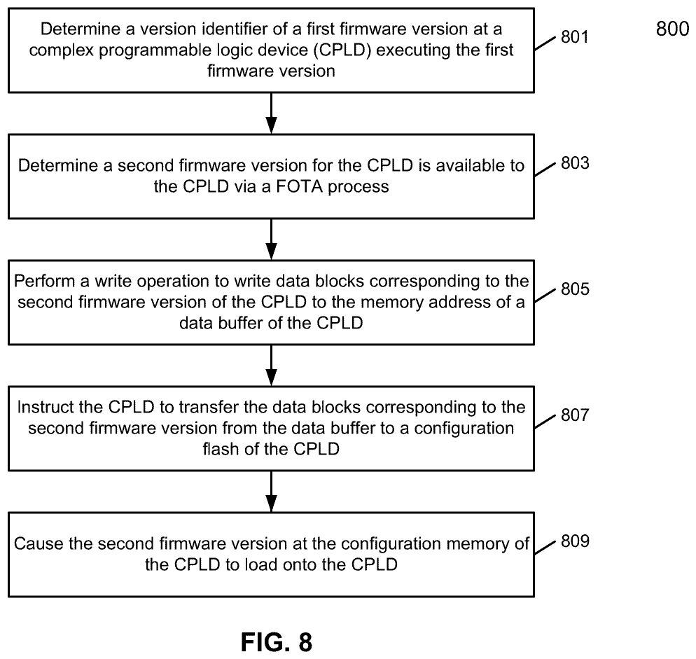

FIG. 8 is a flow diagram illustrating a method to perform FOTA update according to one embodiment. Processing 800 may be performed by processing logic which may include software, hardware, or a combination thereof. For example, process 800 may be performed by FOTA update module 308 of FIG. 3A. Referring to FIG. 8, at block 801, processing logic determines a version identifier of a first firmware version at a complex programmable logic device (CPLD) executing the first firmware version. At block 803, processing logic determines a second firmware version for the CPLD is available to the CPLD via a FOTA process, where a version identifier of the second firmware version is different from the version identifier of the first firmware version. In one embodiment, the second firmware version has a higher version identifier than the version identifier of the first firmware version. At block 805, processing logic performs a write operation to write data blocks corresponding to the second firmware version of the CPLD to a memory address of a data buffer of the CPLD in a block-by-block manner. At block 807, processing logic instructs the CPLD to transfer the data blocks corresponding to the second firmware version from the data buffer to a configuration memory of the CPLD. For example, processing logic sets a value of register file (reg_file) to be the memory address of the configuration memory and executes logic blocks corresponding to a local bus master logic (e.g., logic block 507 of FIG. 5) to transfer firmware data from data buffer to the memory address of the configuration memory.

At block 809, processing logic causes the second firmware version at the configuration memory of the CPLD to load onto the CPLD. For example, processing logic can power cycle the CPLD or configuration the CPLD into a reconfiguration on-the-fly mode to cause the CPLD to reload the firmware version from configuration memory.

In one embodiment, the second firmware version of the CPLD configures the CPLD to perform a power on or a power reset operation for a peripheral component interconnect express (PCIe) device of an autonomous driving vehicle, or perform a power on or power reset operation for one or more sensors of the autonomous driving vehicle.

In one embodiment, processing logic reads a memory address of a register file, retrieves a value of the register file based on the memory address of the register file, and determines the memory address of the configuration memory based on the value of the register file.

In one embodiment, processing logic receives, from a firmware over the air (FOTA) server, data corresponding to the second firmware version. Processing logic determines an integrity of the received data, including determining a checksum of the received data, and comparing the determined checksum and an expected checksum of the received data.

In one embodiment, the data blocks are transferred from the data buffer to the configuration memory of the CPLD in a burst mode.

In one embodiment, read and write operations are performed by a host system onto the CPLD through a microcontroller, where the microcontroller is configured to forward communication packets between the host system and the CPLD. In one embodiment, the read and write operations are performed according to an I2C protocol.

In one embodiment, a host system communicates with a microcontroller via ethernet communication and the microcontroller communicates with the CPLD through an I2C interface. In one embodiment, the CPLD is configured to a reconfiguration on the fly mode for the FOTA process. In one embodiment, processing logic further retrieves a status of the FOTA process indicating whether the FOTA process completed successfully.

Note that some or all of the components as shown and described above may be implemented in software, hardware, or a combination thereof. For example, such components can be implemented as software installed and stored in a persistent storage device, which can be loaded and executed in a memory by a processor (not shown) to carry out the processes or operations described throughout this application. Alternatively, such components can be implemented as executable code programmed or embedded into dedicated hardware such as an integrated circuit (e.g., an application specific IC or ASIC), a digital signal processor (DSP), or a field programmable gate array (FPGA), which can be accessed via a corresponding driver and/or operating system from an application. Furthermore, such components can be implemented as specific hardware logic in a processor or processor core as part of an instruction set accessible by a software component via one or more specific instructions.

Some portions of the preceding detailed descriptions have been presented in terms of algorithms and symbolic representations of operations on data bits within a computer memory. These algorithmic descriptions and representations are the ways used by those skilled in the data processing arts to most effectively convey the substance of their work to others skilled in the art. An algorithm is here, and generally, conceived to be a self-consistent sequence of operations leading to a desired result. The operations are those requiring physical manipulations of physical quantities.

It should be borne in mind, however, that all of these and similar terms are to be associated with the appropriate physical quantities and are merely convenient labels applied to these quantities. Unless specifically stated otherwise as apparent from the above discussion, it is appreciated that throughout the description, discussions utilizing terms such as those set forth in the claims below, refer to the action and processes of a computer system, or similar electronic computing device, that manipulates and transforms data represented as physical (electronic) quantities within the computer system's registers and memories into other data similarly represented as physical quantities within the computer system memories or registers or other such information storage, transmission or display devices.

Embodiments of the disclosure also relate to an apparatus for performing the operations herein. Such a computer program is stored in a non-transitory computer readable medium. A machine-readable medium includes any mechanism for storing information in a form readable by a machine (e.g., a computer). For example, a machine-readable (e.g., computer-readable) medium includes a machine (e.g., a computer) readable storage medium (e.g., read only memory (“ROM”), random access memory (“RAM”), magnetic disk storage media, optical storage media, flash memory devices).

The processes or methods depicted in the preceding figures may be performed by processing logic that comprises hardware (e.g. circuitry, dedicated logic, etc.), software (e.g., embodied on a non-transitory computer readable medium), or a combination of both. Although the processes or methods are described above in terms of some sequential operations, it should be appreciated that some of the operations described may be performed in a different order. Moreover, some operations may be performed in parallel rather than sequentially.

Embodiments of the present disclosure are not described with reference to any particular programming language. It will be appreciated that a variety of programming languages may be used to implement the teachings of embodiments of the disclosure as described herein.

In the foregoing specification, embodiments of the disclosure have been described with reference to specific exemplary embodiments thereof. It will be evident that various modifications may be made thereto without departing from the broader spirit and scope of the disclosure as set forth in the following claims. The specification and drawings are, accordingly, to be regarded in an illustrative sense rather than a restrictive sense.

What is claimed is:

1. A computer-implemented method to perform a firmware over the air (FOTA) process at an autonomous driving vehicle (ADV), comprising:
determining a first firmware version at a complex programmable logic device (CPLD) executing the first firmware version;
determining a second firmware version for the CPLD is available to the CPLD via a FOTA process;
performing a write operation to write data blocks corresponding to the second firmware version of the CPLD to a memory address of a data buffer of the CPLD;
instructing the CPLD to transfer the data blocks corresponding to the second firmware version from the data buffer to a configuration memory of the CPLD; and
causing the second firmware version at the configuration memory of the CPLD to load onto the CPLD.

2. The method of claim 1, wherein the second firmware version of the CPLD configures the CPLD to perform a power on or a power reset operation for a peripheral component interconnect express (PCIe) device of an autonomous driving vehicle, or perform a power on or power reset operation for one or more sensors of the autonomous driving vehicle.

3. The method of claim 1, further comprising:
reading a memory address of a register file;
retrieving a value of the register file based on the memory address of the register file; and
determining the memory address of the configuration memory based on the value of the register file.

4. The method of claim 1, further comprising:
receiving, from a firmware over the air (FOTA) server, data corresponding to the second firmware version; and
determining an integrity of the received data, including:
determining a checksum of the received data; and
comparing the determined checksum and an expected checksum of the received data.

5. The method of claim 1, wherein the data blocks are transferred from the data buffer to the configuration memory of the CPLD in a burst mode.

6. The method of claim 1, wherein read and write operations are performed by a host system onto the CPLD through a microcontroller, wherein the microcontroller is configured to forward communication packets between the host system and the CPLD.

7. The method of claim 6, wherein the read and write operations are performed according to an I2C protocol.

8. The method of claim 1, wherein a host system communicates with a microcontroller via ethernet communication and the microcontroller communicates with the CPLD through an I2C interface.

9. The method of claim 1, wherein the CPLD is configured to a reconfiguration on the fly mode for the FOTA process.

10. The method of claim 1, further comprising retrieving a status of the FOTA process indicating whether the FOTA process completed successfully.

11. A non-transitory machine-readable medium having instructions stored therein, which when executed by a processor, cause the processor to perform operations, the operations comprising:
determining a first firmware version at a complex programmable logic device (CPLD) executing the first firmware version;
determining a second firmware version for the CPLD is available to the CPLD via a FOTA process;
performing a write operation to write data blocks corresponding to the second firmware version of the CPLD to a memory address of a data buffer of the CPLD;
instructing the CPLD to transfer the data blocks corresponding to the second firmware version from the data buffer to a configuration memory of the CPLD; and
causing the second firmware version at the configuration memory of the CPLD to load onto the CPLD.

12. The machine-readable medium of claim 11, wherein the second firmware version of the CPLD configures the CPLD to perform a power on or a power reset operation for a peripheral component interconnect express (PCIe) device of an autonomous driving vehicle, or perform a power on or power reset operation for one or more sensors of the autonomous driving vehicle.

13. The machine-readable medium of claim 11, wherein the operations further comprise:
reading a memory address of a register file;
retrieving a value of the register file based on the memory address of the register file; and
determining the memory address of the configuration memory based on the value of the register file.

14. The machine-readable medium of claim 11, wherein the operations further comprise:
receiving, from a firmware over the air (FOTA) server, data corresponding to the second firmware version; and
determining an integrity of the received data, including:
determining a checksum of the received data; and
comparing the determined checksum and an expected checksum of the received data.

15. The machine-readable medium of claim 11, wherein the data blocks are transferred from the data buffer to the configuration memory of the CPLD in a burst mode.

16. A data processing system, comprising:
a processor; and
a memory coupled to the processor to store instructions, which when executed by the processor, cause the processor to perform operations, the operations including
determining a first firmware version at a complex programmable logic device (CPLD) executing the first firmware version;
determining a second firmware version for the CPLD is available to the CPLD via a FOTA process;
performing a write operation to write data blocks corresponding to the second firmware version of the CPLD to a memory address of a data buffer of the CPLD;
instructing the CPLD to transfer the data blocks corresponding to the second firmware version from the data buffer to a configuration memory of the CPLD; and
causing the second firmware version at the configuration memory of the CPLD to load onto the CPLD.

17. The system of claim 16, wherein the second firmware version of the CPLD configures the CPLD to perform a power on or a power reset operation for a peripheral component interconnect express (PCIe) device of an autonomous driving vehicle, or perform a power on or power reset operation for one or more sensors of the autonomous driving vehicle.

18. The system of claim 16, wherein the operations further comprise:
reading a memory address of a register file;
retrieving a value of the register file based on the memory address of the register file; and
determining the memory address of the configuration memory based on the value of the register file.

19. The system of claim 16, wherein the operations further comprise:
receiving, from a firmware over the air (FOTA) server, data corresponding to the second firmware version; and
determining an integrity of the received data, including:
determining a checksum of the received data; and
comparing the determined checksum and an expected checksum of the received data.

20. The system of claim 16, wherein the data blocks are transferred from the data buffer to the configuration memory of the CPLD in a burst mode.
